(19) United States
(12) Patent Application Publication
(10) Pub. No.: US 2020/0088648 A1
(43) Pub. Date: Mar. 19, 2020

(54) GAS ANALYZER WITH CHEMOCHROMIC SENSOR ASSEMBLY

(71) Applicant: Qualitrol Company LLC, Fairport, NY (US)

(72) Inventors: Kurt Rohmann, Toronto (CA); Benoit Cote, Ottawa (CA); Ke Wang, Ottawa (CA)

(21) Appl. No.: 16/573,839

(22) Filed: Sep. 17, 2019

Related U.S. Application Data
(60) Provisional application No. 62/732,548, filed on Sep. 17, 2018.

(51) Int. Cl. G01N 21/78

(52) U.S. Cl. CPC G01N 21/783

(57) ABSTRACT

A gas analyzer includes a housing adapted for insertion into a chamber. The housing has an open interior with a chemochromic sensor assembly arranged therein which includes a chemochromic media, an electronic color sensor that senses a color of the chemochromic media, and a processor. In operation, the housing is inserted into a chamber, the chemochromic media is exposed to a gas within the chamber, the chemochromic media changes color depending on the gas within the chamber, and the electronic color sensor detects the color of the chemochromic media and communicates a signal to the processor based on the detected color. The processor may be configured to generate gas detection information based on the signal received from the electronic color sensor. A transmitter in communication with the processor communicates at least a portion of the gas detection information from the chemochromic sensor assembly to remote monitoring equipment.

### BACKGROUND

### Technical Field

The present disclosure relates to apparatus and methods for measuring a concentration of gas, e.g., hydrogen, in a chamber. Temperature and moisture may also be measured. In at least one embodiment, the disclosure relates to an apparatus and method for monitoring of electrical insulating oil in electrical equipment.

### Description of the Related Art

The electricity distribution, power generation, and industrial sectors generally recognize that thermal decomposition of oil and other insulating materials within oil-insulated electrical equipment can lead to the generation of a number of “fault gases.” These phenomena occur in equipment such as oil-filled transformers (both conservator and gas-blanketed types), load tap changers, transformer windings, bushings and the like. The quantification and analysis of fault gas concentration can provide an indication of the condition of the equipment. As such, detection of the presence of specific fault gases in electrical equipment, and quantification of the concentration of those gases can be an important part of optimal operation strategies and condition-based maintenance programs.

Various transformer operating conditions including voltage fluctuations, load fluctuations, frequent switching, vibrations, and high operating temperatures can all cause excessive stresses on transformers and possibly premature failures. These conditions increase the occurrence of arcing, partial discharge, and thermal degradation that can cause transformer oils and insulating materials to decompose and generate relatively large quantities of volatile gases including methane, ethylene, acetylene, and hydrogen. It is therefore beneficial to monitor the condition of dielectric fluids in electrical equipment to adjust operational practices and plan maintenance in a way that extends asset life, reduces downtime, avoids safety risks, and minimizes overall lifecycle cost.

Presently, condition monitoring apparatus or devices have been installed on large transmission level assets. However, these devices to date have not been feasible for smaller electrical transmission assets, such as transformers below 100 MVA, when taking into account the cost of purchasing and mounting of the monitoring device, installation of power cables, and the installation of communication cables. In addition to these costs, some transformer locations are not conducive to having a power supply and communication network within close proximity for reporting of conditions monitored by such monitoring apparatus or devices.

### BRIEF SUMMARY

The present disclosure provides reliable apparatus and methods of measuring fault gas (e.g., hydrogen) concentration, temperature, and moisture concentration in a chamber, e.g., of electrical equipment having dielectric insulating oil, at a lower cost than typical devices while also avoiding the additional material and labor costs relating to installation of power and communications cables. Embodiments of the present disclosure include a gas analyzer with a sensor that preferably is self-powered and transmits data without the need for additional power or communications wires, cables or conduits.

A computer application, preferably web based, provides a monitoring dashboard and notification system to ensure that electrical assets, including, e.g., transformers, across a wide geographical area can be quickly reviewed to identify electrical assets showing trends of increasing risk of failure while also receiving automated notifications based on alert thresholds.

In at least one embodiment, disclosed herein is a gas analyzer that includes a housing adapted for insertion into a chamber. The housing has an open interior with a chemochromic sensor assembly arranged in the open interior . The chemochromic sensor assembly includes a chemochromic media, an electronic color sensor configured and arranged with respect to the chemochromic media to sense a color of the chemochromic media, and a processor in communication with the electronic color sensor. In operation, the housing is inserted into a chamber, the chemochromic media is exposed to a gas within the chamber, the chemochromic media changes color depending on the gas within the chamber, and the electronic color sensor detects the color of the chemochromic media and communicates a signal to the processor based on the detected color. In various embodiments, the processor is configured to generate gas detection information regarding the gas within the chamber based on the signal received from the electronic color sensor.

The gas analyzer may further include a transmitter in communication with the processor, wherein the transmitter is configured to communicate at least a portion of the gas detection information from the chemochromic sensor assembly to remote monitoring equipment. In some embodiments, the transmitter may be configured to communicate the gas detection information to a communications gateway that is separate from the gas analyzer, and the communications gateway is configured to communicate the gas detection information to another communications gateway or to the remote monitoring equipment.

In various embodiments, the gas analyzer may further include a temperature and moisture sensor in the open interior of the housing. The temperature and moisture sensor is configured to detect temperature and moisture within the chamber and communicate a signal to the processor based on the detected temperature and moisture. The processor is configured to generate temperature and moisture information based on the signal received from the temperature and moisture sensor, and the transmitter is configured to communicate at least a portion of the generated temperature and moisture information to the communications gateway, and the communications gateway is configured to communicate the temperature and moisture information to the remote monitoring equipment.

In various embodiments, the chamber to which the gas analyzer is connected may be an electrical transformer that contains a dielectric insulating fluid and the gas within the chamber is in the dielectric insulating fluid. In such cases, the chemochromic media is exposed to the dielectric insulating fluid and changes color depending on the gas that is (e.g., dissolved) in the dielectric insulating fluid. The chemochromic media is sensitive to hydrogen gas and changes color when exposed to hydrogen gas in the dielectric insulating fluid.

In some embodiments, the chemochromic media reversibly changes color upon exposure to hydrogen gas. In other embodiments, the chemochromic media irreversibly changes color upon exposure to hydrogen gas.

In various embodiments, the gas analyzer may further include a lens positioned between the chemochromic media and the electronic color sensor. Such lens or lenses may be flat, e.g., acting as a window, or may be curved so as to provide optical effects such as concentrating and focusing light reflecting from the chemochromic media.

In various embodiments, the chemochromic media may be a polyethylene terephthalate (PET) base sheet with a chemochromic material deposited thereon as a metal oxide film. In other embodiments, the chemochromic media may be a fiberglass base sheet or a glass or rigid acetyl-polymer base, with a chemochromic material deposited thereon as a metal oxide film. In the latter embodiments, the glass or rigid acetyl-polymer base may be a lens (e.g., flat window or curved optical shaping device) having the chemochromic material deposited thereon. Other materials may also be used to provide the base on which the chemochromic material is deposited. In various embodiments, the lens may be a translucent lens arranged in a field of view of the electronic color sensor to permit detection of the color of the chemochromic media by the electronic color sensor.

In various embodiments: the chemochromic sensor assembly may further include a gas permeable membrane disposed between the chemochromic media and the chamber; the gas within the chamber to which the chemochromic media is exposed may be in a gas phase or a liquid phase; the processor may be configured to control an operation of the electronic color sensor; the transmitter may be an RF transmitter or a cellular modem configured to wirelessly communicate the gas detection information via radio signal transmission or via cellular signal transmission, respectively, or the transmitter may be a communication circuit configured to communicate the gas detection information via wired electrical and/or optical signal transmission. The gas analyzer may also further comprise a positioning system configured to detect a location of the chamber in which the gas analyzer housing is inserted, wherein the positioning system is configured to communicate a signal based on the detected location of the chamber.

Also disclosed herein is a system that includes a plurality of gas analyzers, e.g., as described above, that are coupleable to a plurality of chambers, along with a communications gateway that is separate from the plurality of gas analyzers. The gas analyzers may be respectively inserted into corresponding chambers of the plurality of chambers. Each gas analyzer may further comprise a transmitter in communication with the processor of the respective gas analyzer, wherein the transmitter is configured to communicate at least a portion of the gas detection information from the chemochromic sensor assembly of the respective gas analyzer to the communications gateway, and the communications gateway is configured to receive the gas detection information from the plurality of gas analyzers and further communicate the gas detection information to remote monitoring equipment.

In various embodiments, the communications gateway may include a rechargeable battery coupled to a battery charging controller. The battery charging controller may have one or more electrical inputs configured to receive power from a power source that includes at least one of a photovoltaic cell, a current transformer, a piezoelectric power harvester, or a power cable. In some embodiments, the photovoltaic cell is disposed on or integrated into the communications gateway to supply power to the battery charging controller.

In various embodiments, the communications gateway may further include a processor configured to control the communication of information through the communications gateway, and a transceiver configured to receive communications from the plurality of gas analyzers and transmit information to the remote monitoring equipment. The transceiver may be at least one of an RF transceiver, a cellular modem, or a wired communications circuit configured to communicate information to the remote monitoring equipment via radio signal transmission, cellular signal transmission, or wired signal transmission, respectively.

### BRIEF DESCRIPTION OF THE SEVERAL VIEWS OF THE DRAWINGS

FIGS. 1-3 illustrate one example embodiment of a gas analyzer according to the present disclosure.

FIG. 4A is a top, front left perspective view of a chemochromic sensor assembly that may be used in a gas analyzer, such as shown in FIGS. 1-3.

FIG. 4B is a top, front right perspective view of an embodiment of the chemochromic sensor assembly shown in FIG. 4A.

FIG. 5 is a side elevation view of a gas analyzer as shown in FIG. 3 with additional detail.

FIG. 6-8 are diagrams illustrating embodiments of a communications gateway configured for use with a gas analyzer according to the present disclosure.

FIG. 9 is a block diagram of a system illustrating aspects of a gas analyzer coupled to a transformer and in communication with a wireless communications gateway and remote monitoring equipment.

FIG. 10 illustrates an exploded view of another embodiment of a gas analyzer having a chemochromic sensor assembly.

FIG. 11 illustrates an exploded view of components of at least one embodiment of the optical stack shown in FIG. 10.

FIG. 12 illustrates an exploded view of an embodiment of a communications gateway 120 constructed in accordance with the present disclosure.

### DETAILED DESCRIPTION

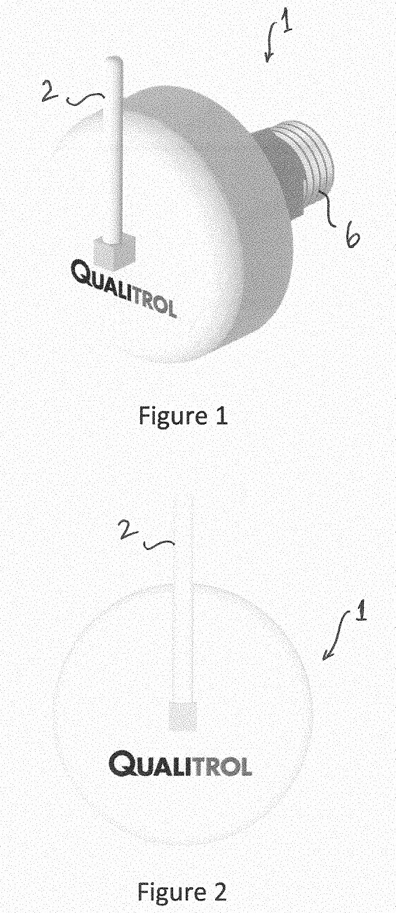

FIGS. 1-3 illustrate one example of a gas analyzer 1 configured in accordance with the present disclosure. In this example, the gas analyzer is configured for easy connection to a chamber, e.g., in a transformer or other electrical equipment. The chamber may have insulating oil, and sensors in the gas analyzer are configured to measure fault gas (e.g., hydrogen) concentration in the insulating oil. Temperature and moisture in the chamber may also be measured.

As illustrated and discussed further below, the gas analyzer 1 has a housing that may be inserted into the chamber. For example, using corresponding threads 6, the gas analyzer 1 may be inserted into either the oil-filled body of the electrical equipment or into the headspace of the electrical equipment above the insulating oil. The housing includes an open interior with a chemochromic sensor assembly 3 that is exposed to gas in the chamber (e.g., dissolved in the insulating oil or in a gas phase in the headspace). The chemochromic sensor assembly 3 has a chemochromic media that sensitive to particular gas or gases and changes color when exposed to the particular gas or gases (e.g., hydrogen) . Additionally, the chemochromic sensor assembly 3 includes an electronic sensor that detects the color of the chemochromic media. The color of the chemochromic media is indicative of the gas (e.g., hydrogen) concentration in the insulating oil or headspace.

In some cases described further below, the gas analyzer 1 includes a temperature and moisture sensor 5 in the open interior of the housing that detects temperature and moisture concentration within the chamber. The temperature and moisture sensor 5 communicates a signal to a processor of the chemochromic sensor assembly based on the detected temperature and moisture, which may generate temperature and moisture information based on the received signal.

The gas analyzer 1 displays the fault gas (e.g., hydrogen) concentration, temperature, and moisture measurements on a local electronic display (e.g., on an outer surface of the analyzer) and/or transmits the fault gas concentration, temperature, and moisture measurements through a communications network to remote monitoring equipment, such as a computer server. The computer server may be, for example, operated in a local or wide area network (e.g., by an owner of the electrical equipment being monitored) or the computer server may be implemented using a “cloud” computing service that provides shared computer server resources that are accessible, for example, via a global network such as the Internet.

The communications network may include wired and/or wireless communication links and one or more communications gateway devices. With wired communication links, for example, the gas analyzer 1 may be coupled to electrical (e.g., copper) or fiber optic lines (e.g., via an Ethernet port), and the electrical or optical lines carry the transmitted measurement data from the analyzer to a communications gateway or to remote monitoring equipment. Accordingly, a communication circuit in the transmitter of the gas analyzer may be configured to communicate the measurement data (gas detection information) via wired electrical and/or optical signal transmission.

With wireless communication links, the communications network may utilize radio frequency transmission channels and/or cellular communication channels to transmit measurement data from the gas analyzer to a communications gateway or to remote monitoring equipment (e.g., a computer server, possibly part of a cloud computing service). In some embodiments, multiple forms of wireless communication may be used. For example, the gas analyzer 1 may have a slot for plug-in card that includes an RF transmitter for wireless transmission of data via RF links (e.g., in an RF mesh network) to a local RF-equipped communications gateway using radio signal transmission, which may use another RF transmitter to transmit the data wirelessly to another RF-equipped gateway, eventually to a gateway equipped with a cellular card/circuit that enables communication of the data to remote monitoring equipment using cellular communication channels. In yet other embodiments, both wired and wireless communication links may be employed (e.g., using RF and/or cellular signal transmission) from individual gas analyzers to a communications gateway that is then coupled to a fiber optic or electrically-wired communications network that conveys the data to the remote monitoring equipment. Transmitted data is preferably stored in a database at the remote monitoring equipment and is analyzed and displayed, e.g., using a web application, to provide needed information to support operations plans and condition-based maintenance programs for the equipment being measured.

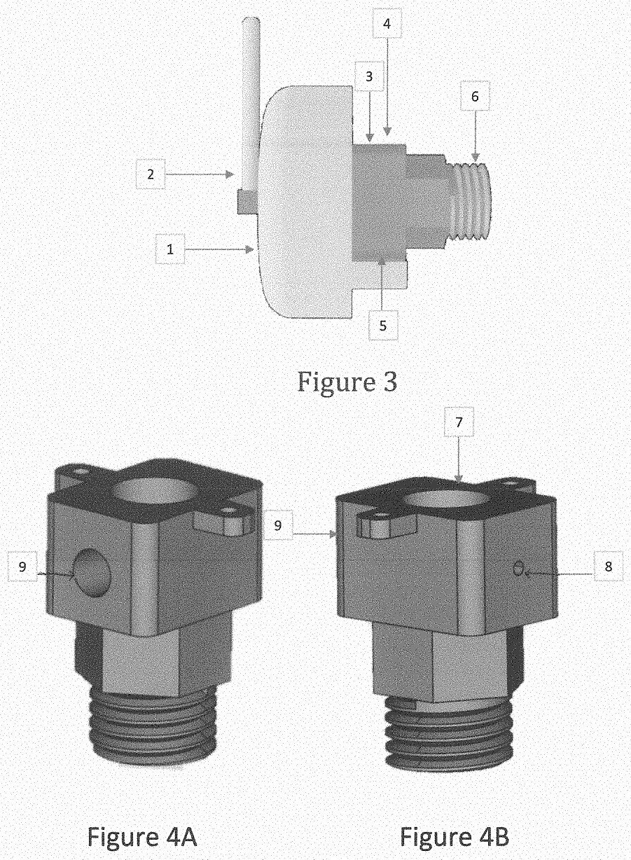

FIG. 1 illustrates a top, front right perspective view of one example of a gas analyzer 1 configured in accordance with the present disclosure. Other examples of the gas analyzer may be configured differently in accordance with the present disclosure. FIGS. 2 and 3 respectively illustrate a front elevation view and a right side elevation view of the gas analyzer 1 shown in FIG. 1.

In the view shown in FIG. 3, the gas analyzer 1 includes a body and a communications antenna 2. The body is preferably constructed using a rugged weatherproof material, such as acrylonitrile butadiene styrene (ABS), polycarbonate, or the like. The gas analyzer further includes a chemochromic sensor assembly 3, as well as a bleed valve 4 and a temperature and humidity sensor 5. When the gas analyzer is inserted into a chamber, e.g., in electrical equipment, a threaded connection 6 provides for coupling and securing the gas analyzer 1 to the chamber.

The chemochromic sensor assembly 3 includes an electronic color sensor that is communicatively coupled to a processor, such as a programmed microprocessor or a special-purpose integrated circuit. The processor is configured to generate gas detection information regarding the gas in the chamber to which the gas analyzer 1 is exposed, based on a signal received from the electronic color sensor in the gas analyzer. As will be discussed further below, in one or more embodiments, the processor may be communicatively coupled to a transmitter which may be, for example, a radio frequency (RF) transceiver and/or a cellular (e.g., LTE) embedded modem. The transmitter is configured to communicate at least a portion of the gas detection information from the chemochromic sensor assembly in the gas analyzer to remote monitoring equipment.

In the embodiment illustrated in FIGS. 1-3, the communications antenna 2 is mounted external to the body of the gas analyzer 1 and is connected through front facia of the body to the transmitter. Alternatively, in other embodiments, the communications antenna 2 is mounted internal to the body. In either case, the transmitter of the gas analyzer 1 coupled to the antenna 2 provides wireless communication between the gas analyzer and remote monitoring equipment, possibly via one or more communications gateways that are separate from the gas analyzer. In the latter case, the transmitter is configured to communicate the gas detection information to a communications gateway, and the communications gateway is configured to communicate the gas detection information to the remote monitoring equipment. In some cases, the communications path for communicating the gas detection information from the gas analyzer 1 to the remote monitoring equipment may include multiple communications gateways. The transmitter may also be configured to communicate generated temperature and moisture information (or at least a portion thereof) to the communications gateway, and the communications gateway is configured to communicate the temperature and moisture information to the remote monitoring equipment.

In some embodiments, the gas analyzer 1 includes a positioning system with a GPS chip that detects the location of the gas analyzer and the chamber in which the gas analyzer is inserted. The positioning system is configured to communicate a signal based on the detected location of the chamber. In other embodiments, power management may limit the amount of time that the processor and sensor(s) of the gas analyzer 1 are active (e.g., periodically turned on for only a limited number of seconds to obtain and transmit measurement data) and in such embodiments, a GPS chip would have insufficient time to obtain positional data from GPS satellites. With such embodiments, a GPS chip may instead be operated in a calibration tool used to calibrate the sensors in the gas analyzer 1. During calibration, positional data for a particular gas analyzer may be obtained by the GPS chip in the calibration tool and downloaded to persistent memory in the gas analyzer, for later reporting by the gas analyzer when the chemochromic sensor assembly communicates measurement data it has generated. If the gas analyzer 1 is relocated to different equipment and the gas analyzer is again calibrated, new positional data obtained by the GPS chip in the calibration tool is downloaded to the memory in the gas analyzer, replacing the previously-downloaded positional data.

Turning to FIGS. 4A and 4B, an example embodiment of the chemochromic sensor assembly 3 includes a first aperture 7 for a lens, a second aperture 8 for the bleed valve, and a third aperture 9 for the temperature and moisture sensor. The third aperture 9 preferably is plugged when the gas analyzer is deployed without a temperature and moisture sensor. When the gas analyzer 1 is inserted into a chamber (e.g., of a transformer), the bleed valve 4 allows air to escape and dielectric insulating oil or gas in the chamber to fill the chemochromic sensor assembly 3 or at least a portion thereof. The chemochromic sensor assembly 3 contains a chemochromic media that is configured to change color when exposed to a particular gas, such as hydrogen gas, in the insulating oil or headspace of the chamber of the electrical equipment to which the gas analyzer is attached.

One example of a chemochromic media that may be used or adapted for use in the gas analyzer of the present disclosure is described in detail in U.S. Pat. No. 8,999,723 (“the '723 patent”), assigned to Serveron Corporation, the disclosure of which is incorporated herein. The '723 patent describes a reliable, low cost sensing device that detects and indicates the presence of dissolved hydrogen gas in a transformer. The device includes hexagonal head and a chemochromic sensor assembly 3 having an exposed end that threads into either the headspace or into the oil-filled body of a transformer.

In this example, the chemochromic sensor assembly 3 contains a chemochromic media in the form of an indicator film that has a hydrogen-sensitive chemochromic indicator incorporated or applied thereto. The indicator film is visible through a translucent lens (which may be partially or fully transparent), such as the lens located in aperture 7 shown in FIG. 4B. When the indicator film is exposed to hydrogen gas in the transformer, chemical changes in the chemochromic indicator cause the indicator film to change color. The color of the indicator film is indicative of the detected hydrogen concentration and is visible through the lens.

In this example, the transformer (or other electrical equipment to which the gas analyzer is attached) includes a threaded port that opens to a chamber in the interior of the transformer where the insulating oil is contained. The threaded port may be positioned either above or below the level of the insulating oil in the transformer and receives the threaded end 6 of the chemochromic sensor assembly 3. The gas analyzer 1 may therefore be inserted into the chamber of the transformer such that the chemochromic sensor assembly 3 is located in the headspace above the oil or immersed in the oil. In either case, the gas analyzer 1 is threaded into the threaded port of the transformer and is snugly tightened to prevent leaks. While in some embodiments a gasket may be used to ensure a leak-free seal between the gas analyzer and the transformer to which the gas analyzer is attached, in a preferred embodiment Teflon tape or pipe dope (thread compound or pipe thread sealant) is used to seal the gas analyzer 1 in the chamber of the transformer.

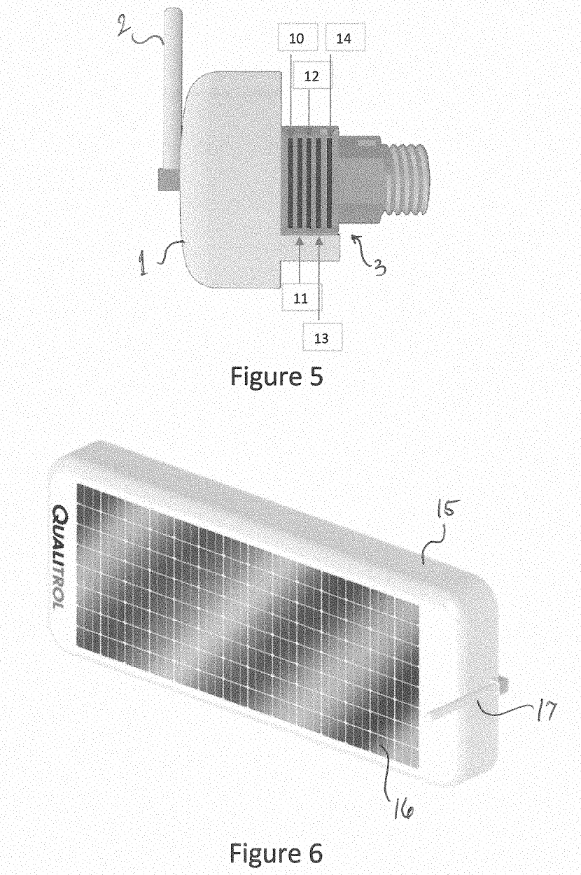

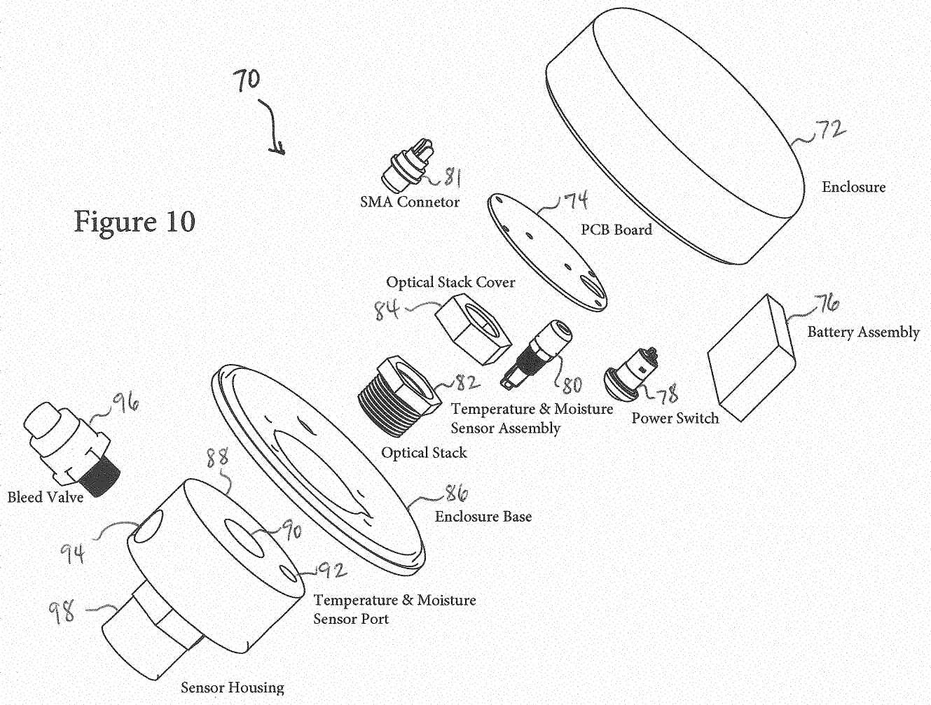

Additional details regarding an embodiment of the chemochromic sensor assembly 3 is shown pictorially in FIG. 5, while another embodiment of the chemochromic sensor assembly 3 is shown pictorially in FIGS. 10-12.

In FIG. 5, a lens 10 is fitted outward from a chemochromic media (e.g., indicator film) 11, i.e., toward the body of the gas analyzer 1 and away from the threaded opening 6 of the chemochromic sensor assembly 3. A fluoroelastomer membrane 12 may thereafter be fitted, possibly adjacent to a fluoroelastomer O-ring 13 and a frit 14 as described in the '723 patent. Use of fluoroelastomer materials is by way of example only, and is not limiting to the present disclosure. Furthermore, an O-ring and frit may or may not be used and are not required, as will be seen by way of the example shown in FIGS. 10-12.

The frit 14 (if included) may be positioned within a circumference of the O-ring 13 such that the frit 14 rests on an annular seat within the chemochromic sensor assembly 3. The frit 14 may be a porous disk material through which oil and/or other liquids or gas readily flow. In some cases, the frit 14 may be sintered bronze. In other cases, the frit 14 may be fabricated from other porous materials including sintered glass, sintered metals, or wire mesh and/or other materials.

The chemochromic media 11 is treated with a chemochromic indicator material that is sensitive to a particular gas or gases (hydrogen, in this example) so that when the chemochromic media is exposed to the particular gas or gases (e.g., hydrogen), the color of the chemochromic media changes. One example of a suitable chemochromic media 11 is an indicator film as described in U.S. Pat. No. 6,895,805, the disclosure of which is incorporated herein by reference. The chemochromic media 11 may be of a type that reversibly changes color upon exposure to a particular gas, such as hydrogen gas, or of a type that irreversibly changes color upon exposure to such gas, or a combination of both types. In embodiments of the gas analyzer that include a frit 14, the frit preferably lies adjacent to the chemochromic media 11 and supports the chemochromic media 11 to prevent mechanical damage.

In embodiments that use an indicator film as the chemochromic media 11, the chemochromic media may include a multi-layered sheet having at least a gas sensor layer and an adjacent carrier layer onto which the gas sensor layer is deposited. The carrier layer facilitates handling of the indicator film 11 and may be formed of any appropriate sheet material cut into a desired shape and size. In at least one non-limiting example, the chemochromic media 11 is a polyethylene terephthalate (PET) base sheet that has a chemochromic material deposited thereon, e.g., as a metal oxide film. In another non-limiting example, the chemochromic media 11 is a fiberglass base sheet that a chemochromic material, e.g., a metal oxide film, deposited thereon.

The lens 10 is a translucent lens (or combination of lenses) made of glass or appropriate plastic material, which may be fitted to the aperture 7 shown in FIGS. 4A and 4B to allow protected viewing of the color of the chemochromic media 11. The translucent lens allows light to pass through, and may be partially or fully transparent. The lens 10 may be positioned between the chemochromic media 11 and the electronic color sensor. The lens 10 may be constructed to have a flat surface, e.g., as a window that provides the electronic color sensor with a view of the chemochromic media, or the lens 10 may be curved so as to provide optical effects such as concentrating and focusing light that reflects from the chemochromic media onto the electronic color sensor of the chemochromic sensor assembly 3. In some embodiments, the chemochromic media 11 is a glass or rigid acetyl-polymer base that has a chemochromic material deposited thereon, e.g., as a metal oxide film. In some embodiments, the chemochromic media 11 and the lens 10 are combined, such that the lens 10 comprises a glass or a rigid acetyl-polymer base with chemochromic material deposited thereon, e.g., as a metal oxide film.

In some embodiments that include a frit 14, the chemochromic sensor assembly 3 may include a gas permeable membrane 12 adjacent to and externally of the frit 14 (if used) and interiorly of the chemochromic media (e.g., indicator film) 11. The interior of chemochromic sensor assembly is open so that the chemochromic media 11 is exposed to either or both the gas and/or oil (with dissolved gas) contained in the chamber of the transformer, depending on the location where the chemochromic sensor assembly 3 in inserted into the chamber. As such, the chemochromic sensor assembly may include a gas permeable membrane disposed between the chemochromic media 11 and the chamber. The gas within the chamber to which the chemochromic media 11 is exposed may be in a gas phase or dissolved in a liquid phase (e.g., insulating oil).

The gas analyzer described herein may be coupled to a transformer (or other electrical equipment) either during the manufacture of the transformer or by insertion into the transformer after installation of the transformer. In either case, the chemochromic sensor assembly 3 of the gas analyzer is inserted (e.g., threaded) into the chamber of the transformer using a (threaded) port of the transformer as described herein.

The chemochromic sensor assembly 3 is oriented and arranged so that an electronic color sensor therein has a field of view of the chemochromic media 11 via the lens 10. If the chemochromic media 11 has been exposed to a gas such as hydrogen (either dissolved in the insulating oil or free gas in the headspace of the transformer), the chemochromic media 11 exhibits a change in color. As will be described below, the electronic color sensor is configured to sense the color of the chemochromic media 11 and provide a signal based on (or indicative of) the sensed color to the processor of the sensor assembly 3 for further processing and communication to remote monitoring equipment, either directly or via one or more communications gateways.

As illustrated in FIGS. 4A and 4B, the chemochromic sensor assembly 3 includes the port 8 for the bleed valve 4, and the port 9 for a combined temperature and moisture sensor 5. Suitable electronics for sensing temperature and moisture (humidity) are known to persons of ordinary skill in the art and are available for integration into the assembly 3. For example, the chemochromic sensor assembly 3 may use a commercially-available temperature and moisture sensor that is known in the art.

The temperature and moisture sensor 5 is preferably co-located in the chemochromic sensor assembly 3, thus allowing relative humidity in the sensor assembly 3 to be temperature compensated while also providing a second, standalone temperature sensor output. The temperature sensor is preferably located at the moisture sensor's active area. In at least one suitable embodiment, a slightly hydroscopic porous material is layered between two electrodes. As the humidity increases, the dielectric constant of the non-conductive material changes, which in turn changes the capacitance between the electrodes which is measurable. The porous material expands or contracts slightly, depending on the amount of water vapor in the surrounding volume. In at least one suitable embodiment, a 1000 Ohm platinum resistance temperature detector is mounted on the back of a ceramic sensor substrate of the moisture sensor. The resistance temperature detector includes a resistance thermometer element, internal connecting wires, a protective shell, and a connecting wire, as appropriate to the particular configuration. Signal conditioning circuitry may also be included on-chip with the humidity sensing capacitor.

Disposed within the body 1 of the gas analyzer and included in the chemochromic sensor assembly 3 is an electronic color sensor that can sense the color of the chemochromic media 11. In at least one embodiment, the color sensor may be a TCS3200 or TCS 3210 programmable RGB color light-to-frequency converter manufactured by Texas Advanced Optoelectronic Solutions (TAOS). One or more lighting elements (e.g., LEDs) that produce light of a desired wavelength or wavelengths may be implemented to provide light on or around the chemochromic media that enables the color sensor to detect and measure the color of the chemochromic media.

In one suitable example, the electronic color sensor may include silicon photodiodes and a current-to-frequency converter on a single integrated circuit. The output is a signal having a frequency that is directly proportional to light intensity (irradiance). Digital inputs and outputs are in communication with a processor or other logic circuitry of the chemochromic sensor assembly 3. In an example using the TCS3200, the light-to-frequency converter reads an 8×8 array of photodiodes. Sixteen of the photodiodes are positions below blue wavelength filters, sixteen of the photodiodes are positioned below green wavelength filters, and sixteen of the photodiodes are positioned below red wavelength filters, while the remaining sixteen photodiodes are not positioned with regard to any color wavelength filters. In this embodiment, photodiodes positioned under the same color wavelength filter are connected in parallel.

While the TCS3200 outputs a signal based on a sensed RCG color space, other electronic color sensors suitable for use in the chemochromic sensor assembly 3 include, for example, sensors that detect colors in a CIE XYZ color space. Such sensors typically are more expensive and provide better color measurement, but may not be necessary for suitable operation of a gas analyzer as described herein.

In at least one embodiment, the electronic color sensor is communicatively coupled to a custom-configured logic board using an Atmega3238PB microprocessor. A custom-configured board is advantageous in that it may offer greater flexibility to minimize power consumption and cost. In other embodiments, different computing logic arrangements may be used (an example being an Arduino Uno Rev3). The Arduino Uno is a microcontroller board based on the ATmega328P.

In the above-described embodiment, the logic board is configured to (1) control the electronic color sensor and temporarily store measurement data (e.g., R,G,B values) until the data is sent in a data packet by a transceiver of the gas analyzer; (2) control the temperature and moisture sensor to obtain measurements of temperature, relative humidity, and possibly time stamp values; and (3) package the data into a time stamped data packet and transmit the packet by the transceiver to a communications gateway or remote monitoring equipment. In at least one embodiment, the logic board has been implemented using a stripped-down Dragino architecture with a HopeRF95/96/97/98(W) RF transmitter integrated onto the board.

In various embodiments, the logic board and transceiver may operate as a mesh networking control node that accepts data from other gas analyzers and retransmits the data accordingly. In other embodiments, particularly where power management techniques are employed, the logic board does not operate as a mesh networking node, but rather simply periodically activates, obtains a series of measurements using its local chemochromic sensor assembly 3, computes an average of those measurements, and transmits the measurement average to a communications gateway or remote monitoring device, after which the logic board returns to an inactive state. Generally, the communications gateway remains in a continuous or substantially continuous active state so that it may receive measurement data at different times from different gas analyzers, and possibly from other communications gateways, and re-transmit the measurement data to the remote monitoring equipment (or to yet another communications gateway to eventually be transmitted at a final gateway node to the remote monitoring equipment). The final communication link to the remote monitoring equipment may be provided by a cellular-equipped gateway that communicates the data via cellular data communication channels (e.g., LTE over TCP/IP) to the remote monitoring equipment (e.g., cloud computer server).

The logic board may enable encryption so that there is end-to-end encrypted data (encrypted before the data transmitted via RF signals, encrypted while the data sent through a cellular communications gateway or such, encrypted in an SQL database, etc.). Conversion of the detected color data to values representing fault gas (e.g., hydrogen) concentration may be performed by the processor in the gas analyzer, by a processor in the remote monitoring equipment (e.g., in the programming of a web application and/or database operating in the remote monitoring equipment), or in a separately-executed application, possibly by a processor that is accessible and operable elsewhere in the cloud.

At least one embodiment of the disclosure may use a LoRa Shield that is a long range transceiver implemented using an Arduino shield form factor and based on an open source library. The LoRa Shield allows a user to send data and reach long ranges at low data rates. It provides ultra-long range spread spectrum communication and high interference immunity while minimising current consumption. A LoRa Shield based on RFM95W targets professional wireless sensor network applications such as irrigation systems, smart metering, smart cities, smartphone detection, building automation, and so on. Using HopeRF's LoRa™ modulation technique, the LoRa Shield can achieve a sensitivity of over −148 dBm using a low-cost crystal and bill of materials. The high sensitivity combined with the integrated +20 dBm power amplifier yields an industry-leading link budget, making it optimal for applications requiring range or robustness. LoRa™ modulation also provides significant advantages in both blocking and selectivity over conventional modulation techniques, solving the traditional design compromise between range, interference immunity, and energy consumption.

These devices also support high performance (G)FSK modes for systems including WMBus, IEEE802.15.4g. The LoRa Shield delivers exceptional phase noise, selectivity, receiver linearity, and IIP3 for significantly lower current consumption than competing devices.

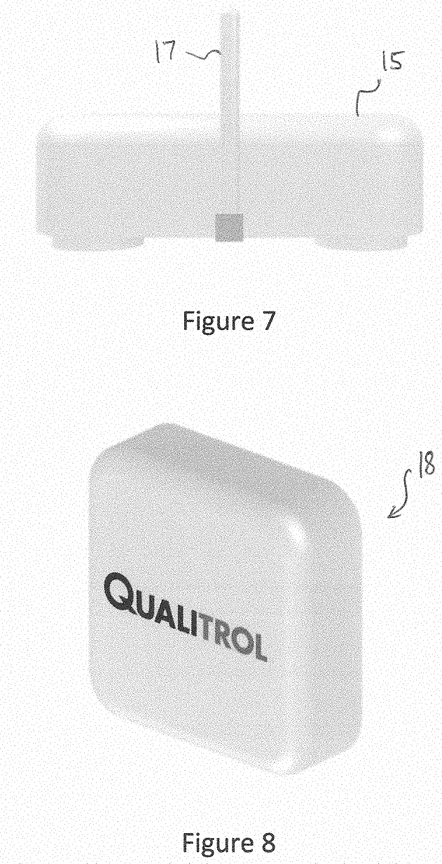

FIG. 6-8 depict diagrams of example embodiments of a communications gateway 15 configured for use with a gas analyzer 1 according to the present disclosure. In particular, FIG. 6 provides a perspective view of one example of a communications gateway 15 that is powered by photovoltaic solar cells 16 arranged on or in an upper surface of the gateway housing. With this embodiment, the communications gateway 15 may be configured to generate and locally store power that is necessary for operation of the communications gateway without needing to hardwire to a power source or otherwise obtain electrical power from other sources (e.g., power harvesting from existing powered electrical lines). The communications gateway 15 is shown having a communications antenna 17 arranged external to the gateway housing. FIG. 7 illustrates a front view of a communications gateway, which may be the solar-powered communications gateway 15 shown in FIG. 6 or another communications gateway 18 powered by another source (e.g., an internal battery or electrical tap to another source of power), an example of which is shown in perspective view in FIG. 8 with an internally-arranged communications antenna.

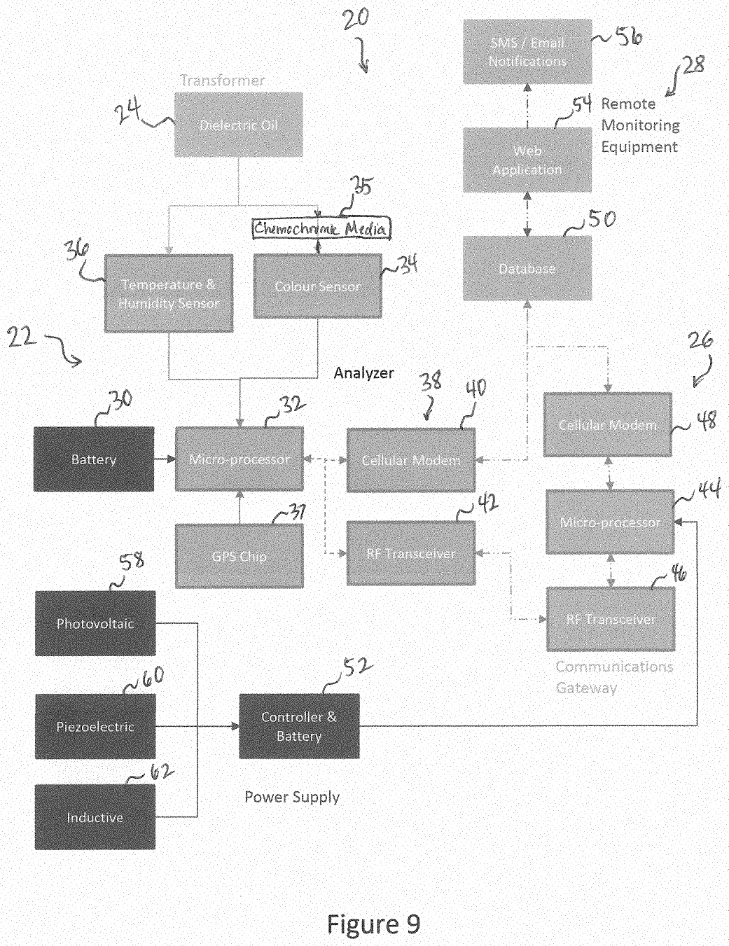

FIG. 9 is a block diagram of a system 20 illustrating aspects of a gas analyzer 22 coupled to a transformer 24. The gas analyzer 22 is in communication with a communications gateway 26 and remote monitoring equipment 28. The gas analyzer 22, similar to the gas analyzer 1 discussed above, is powered by a battery 30. A microprocessor 32 in the gas analyzer 22 controls the electronic components, such as the color sensor 34 and the temperature/humidity sensor 36, in the gas analyzer. The gas analyzer 22 may, in some embodiments, further include a positioning system with a GPS chip 37 that detects the location of the gas analyzer 22 and the chamber to which the gas analyzer 22 is attached. Data generated by the respective color sensor 34, temperature/humidity sensor 36, and GPS chip 37 is processed by the microprocessor 32 and transmitted through a transmitter 38 (an RF transceiver 40 and/or a cellular modem 42) to the remote monitoring equipment 28, directly or through the communications gateway 26. For example, when data is transmitted through the cellular modem 42, the data may be transmitted directly to remote monitoring equipment 28 operating a cloud-based computer server resource. When the data is transmitted through the RF transceiver 40, the data may be transmitted through a mesh network of RF transceivers (with other gas analyzers 22 and/or communications gateways 26 acting as nodes in the network) to the remote monitoring equipment 28.

The communications gateway 26, as shown, has a microprocessor communicative coupled to an RF transceiver 46 and/or a cellular modem 48. The data is then communicated by the communications gateway 26 to a database 50 operating in the remote monitoring equipment 28. The remote monitoring equipment 28 is preferably configured to evaluate the received data, which represents a detected gas concentration based on the color of the chemochromic media 35 sensed by the color sensor 34 or gas detection information generated by the gas analyzer 22 based on the sensed color of the chemochromic media 35. The received data may also include data representing the temperature and/or moisture sensed by the temperature and humidity sensor 36. Based on this data, the remote monitoring equipment 28 may determine whether the fault gas (e.g., hydrogen) concentration sensed by the gas analyzer 22 is trending toward or has reached an alarm or notification threshold level.

The communications gateway 26 (as well as the gas analyzer 22) may be powered using one or more power harvesting technologies, including photovoltaics, piezoelectric power harvesting, and inductive power harvesting. The charging of batteries for the communications gateway may be controlled by a charge controller 52. In various implementations, the communications gateway 26 may be located on top of a transformer, a tower, mezzanine or other structure separate from the gas analyzer 22. A gas analyzer 22 that is powered using one or more power harvesting technologies may also have a charge controller that controls charging of the battery in the gas analyzer.

Data stored in the database 50 of the remote monitoring equipment 28 may be organized in accordance with information (possibly included in the database as metadata) such as company name, site, location, and asset identification so that the data can be identified, accessed, and analyzed by operating personnel according to defined access right rules. Conversion of the color measurement data to gas detection information (e.g., values representing the detected hydrogen concentration in a particular transformer) may be performed by the microprocessor 32 in the gas analyzer 22, by the microprocessor 44 in the communications gateway 26, and/or by a web application 54 operating the remote monitoring equipment 28. A computer (e.g., web-based) application 54 operating in the remote monitoring equipment may include programming that automatically analyzes the sensor data or gas detection information received from various gas detection analyzers, e.g., with respect to threshold values, and provides automated notifications 56 that direct the attention of operating personnel to transformers 24 showing trends of increased hydrogen concentration, and therefore increased risk of failure.

The present disclosure further includes a system comprising a plurality of gas analyzers 22 that are coupled to a plurality of chambers (e.g., in a plurality of transformers 24). The gas analyzers 22 may be constructed as described above. Thu system also includes a communications gateway 26 that is separate from the plurality of gas analyzers.

With this system, each gas analyzer 22 of the plurality of gas analyzers is respectively inserted into a corresponding chamber of the plurality of chambers. Furthermore, each gas analyzer 22 further comprises a transmitter 38 in communication with the 32 processor of the respective gas analyzer. The transmitter 38 in each gas analyzer 22 is configured to communicate at least a portion of the gas detection information from the chemochromic sensor assembly 34, 35 of the respective gas analyzer to the communications gateway 26. The communications gateway 26 is configured to receive the gas detection information from the plurality of gas analyzers 22 and further communicate the gas detection information to remote monitoring equipment 28.

To power the communications gateway(s) 26 in the above system, a rechargeable battery may be coupled to a battery charging controller 52 in the respective communications gateway. The battery charging controller 52 may have one or more electrical inputs configured to receive power from a power source that includes at least one of a photovoltaic cell 58, a piezoelectric power harvester 60, an inductive current transformer 62, or a power cable (not shown). In some cases, the photovoltaic cell 58 is disposed on or integrated into a housing of the respective communications gateway 26 to supply power to the battery charging controller 52. In some cases where the communications gateway is coupled to a network using a wired Ethernet connection, the communications gateway may be configured to pull power from the network using Power Over Ethernet.

With the above system, the communications gateway 26 may further include a processor 44 that is configured to control the communication of information through the communications gateway 26. A transceiver 46 in the communications gateway 26 is configured to receive communications from the plurality of gas analyzers 22 and to transmit information to the remote monitoring equipment 28. The transceiver 46 may be at least one of an RF transceiver, a cellular modem, or a wired communications circuit, configured to communicate information to the remote monitoring equipment 28 via radio signal transmission, cellular signal transmission, or wired signal transmission, respectively.

As may be appreciated from the foregoing description, the present disclosure also provides an improved method of monitoring a transformer 24 (or other electrical equipment) for the presence and concentration of a gas, such as hydrogen gas. Embodiments of the method include inserting at least a portion of a gas analyzer 22, comprising a chemochromic sensor assembly 34, 35 as previously described, into the transformer/equipment being monitored. At least the chemochromic media 4 of the chemochromic sensor assembly is exposed to an interior space of the chamber in the transformer 24. The interior space of the chamber typically contains a dielectric insulating oil. The chemochromic media 35 in the chemochromic sensor assembly, which changes color in the presence of hydrogen gas, is positioned within the field of view of the electronic color sensor 34. The method further includes causing the color sensor 34 to sense the color of the chemochromic media 35 and generate measurement values that are transmitted from the gas analyzer 22 to a remote monitoring system 28, either directly or through a communications gateway 26. In some embodiments, a microprocessor 32 in the gas analyzer 22 is programmed to activate the color sensor 34, periodically or in response to a triggering command received from the remote monitoring system 28 and/or communications gateway 26. Based on the measurement values or other gas detection information, the method includes determining whether the chemochromic media 35 indicates the presence of hydrogen gas that exceeds an acceptable threshold. In some embodiments, the measurement values generated by the color sensor 34 may indicate whether the chemochromic media 35 has changed from a first color to a second color. Based on either the measurement values or a determined color change, the concentration of hydrogen gas that is present in the transformer chamber 24 may be determined. The hydrogen concentration is preferably then communicated and stored in a database 50 (such as cloud-based SQL database) operating in the remote monitoring equipment 28, and presented to operating personnel, e.g., via a web application 54 operated by the remote monitoring equipment.

The step of inserting the gas analyzer 22 into the transformer 24 may include directly exposing the chemochromic media 35 to the insulating oil of the transformer 24. Alternatively, the gas analyzer 22 may be inserted into the transformer 24 so that the chemochromic media 35 is exposed to a headspace in the transformer 24 above the insulating oil, possibly such that the chemochromic media 35 is not directly exposed to the insulating oil but rather to the gas that is present in the headspace. In some embodiments, the gas analyzer 22 may be installed in a fill plug of the transformer 24 or installed in a drain valve of the transformer 24, where the chemochromic media 35 is exposed to the dissolved gas in the insulating oil.

FIG. 10 illustrates an exploded view of another embodiment of a gas analyzer 70 having a chemochromic sensor assembly. The gas analyzer 70 includes various electrical components that, for the most part, are assembled within an enclosure 72, including a printed circuit board (PCB) 74 having a color sensor, a processor, a transmitter, and other operational electronic circuitry of the gas analyzer 70 incorporated thereon.

Electrically coupled to the PCB 74 are a battery assembly 76, a power switch 78, a temperature and moisture sensor assembly 80, and an SMA connector 81. The battery assembly 76 provides power to the electrical components inside the enclosure 72, including the circuitry and components of the PCB 74. The power switch 78, which may be arranged at least partially external to the enclosure 72, allows a user to manually activate or deactivate the gas analyzer 70. The temperature and moisture sensor assembly 80, in operation, senses the temperature and moisture (humidity) within a chamber to which the gas analyzer 70 is attached. The temperature and moisture sensor assembly 80 may operate in accordance with control signals issued by the processor on the PCB 74 and report measurement data to the processor as described earlier herein. The SMA connector 81 is a coaxial RF connector that allows a calibration device to couple to the gas analyzer 70 for calibration of the gas analyzer.

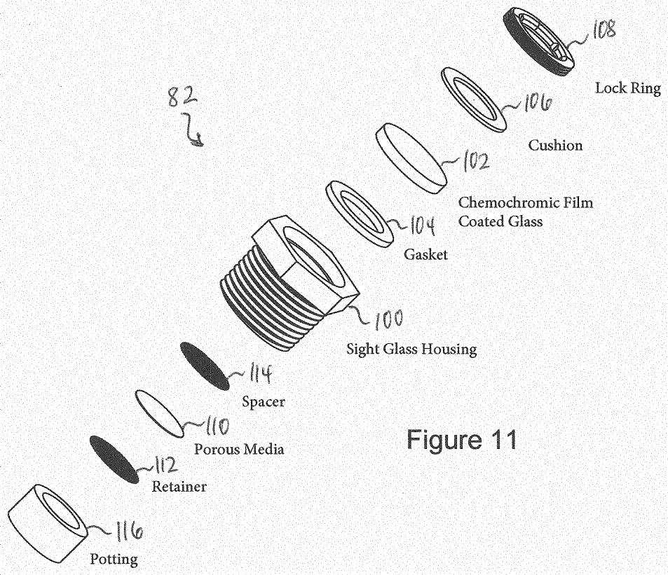

Disposed adjacent to the color sensor on the PCB 74 is chemochromic sensor assembly comprising an optical stack 82 that fits within an optical stack cover 84. Both the optical stack cover 84 and the optical stack 82 have a central circular aperture through which the color sensor on the PCB 74 can view chemochromic media disposed within the optical stack 82, as described in greater detail with regard to FIG. 11.

Fitted to the bottom of the enclosure 72 is an enclosure base 86 having a central aperture through which at least a portion of a sensor housing 88 is disposed. The sensor housing 88 includes a central aperture 90 that receives a threaded portion of the optical stack 82. Adjacent to the central aperture 90 is another aperture 92 that receives a threaded portion of the temperature and moisture sensor assembly 80. On a side of the sensor housing 88 is a further aperture 94 that receives a threaded end of a bleed valve 96 that allows air to escape the chemochromic sensor assembly, e.g., during installation of the gas analyzer 70 in a chamber to be monitored. A bottom end 98 of the sensor housing 88 fits within the chamber and provides a passage for gas or liquid (e.g., dielectric insulating fluid) in the chamber to flow into the chemochromic sensor assembly of the gas analyzer 70.

FIG. 11 illustrates an exploded view of components of at least one embodiment of the optical stack 82 shown in FIG. 10. Central to the optical stack 82 is a sight glass housing 100. Fitted within a top end of the sight glass housing 100 is a translucent chemochromic film coated glass 102 (which may constitute a lens, as described earlier herein). The glass 102 is directly coated with a film of chemochromic media as described herein. The chemochromic film coated glass 102 is sandwiched between a gasket 104 and a cushion 106 that are held in place within the sight glass housing 100 by a lock ring 108. The gasket 104 and the cushion 106 are fitted against the chemochromic film coated glass 102 and sealingly engage the coated glass 102 to prevent liquid and/or gas from flowing past the coated glass 102. The lock ring 108 has external threads that correspond to threads of the sight glass housing 100 defined internally at the top end of the sight glass housing. When the lock ring 108 is threaded into the sight glass housing 100, the chemochromic film coated glass 102 is securely and sealingly held within the sight glass housing 100. In an alternative embodiment, the chemochromic film coated glass 102 (and gasket, cushion, and/or lock ring as needed) may be directly integrated into the sensor housing 88 (FIG. 10) rather than in a separate sight glass housing 100 (optical stack 82) that is threaded into the sensor housing 88.

Fitted within a bottom end of the sight glass housing 100 is a porous media 110 that, in this particular embodiment, is sandwiched between a retainer 112 and a spacer 114. The retainer 112 and/or the spacer 114 may be constructed of a PTFE lattice mesh or other material that suitably allows gas and/or insulating oil in the chamber being monitored to pass through the sight glass housing 100 to the chemochromic film coated glass 102. In some embodiments, the retainer 112 and/or the spacer 114 may be excluded, or alternative mesh types or materials could be employed. In the illustrated embodiment, potting 116 is used to hold the retainer 112, the porous media 110, and the spacer 114 within bottom end of the sight glass housing 100.

The porous media 110 is preferably made of a material, e.g., PTFE, that provides a white-colored background for improved measurement of the color of the chemochromic media on the chemochromic film coated glass 102. A color sensor on the PCB 74 (FIG. 10) has a field of view through the central aperture of the lock ring 108 and the cushion 106 to the chemochromic media on the chemochromic film coated glass 102. In the field of view behind the chemochromic film coated glass 102 is the white porous media 110. The lattice mesh of the spacer 114 that is fitted adjacent to the porous media 110 does not substantially obscure the white porous media 110 from the view of the color sensor. The white color of the porous media 110 enables the color sensor of the PCB 74 to obtain a better reading of the color of the chemochromic media on the chemochromic film coated glass 102. The PTFE material may be oleophobic so that the gas/oil from the chamber may permeate the retainer 112, spacer 114, and/or porous media 110 without altering the white background provided by the porous media. A light source such as an LED (not shown in FIG. 11) may be incorporated into the sight glass housing 100 to provide light within the chemochromic sensor assembly that facilitates sensing of the color of the chemochromic media by the color sensor. In some embodiments, it may be acceptable to coat the chemochromic media on the porous media 110 or the spacer 114, which are in the field of view of the color sensor on the PCB 74, in place of coating the glass 102.

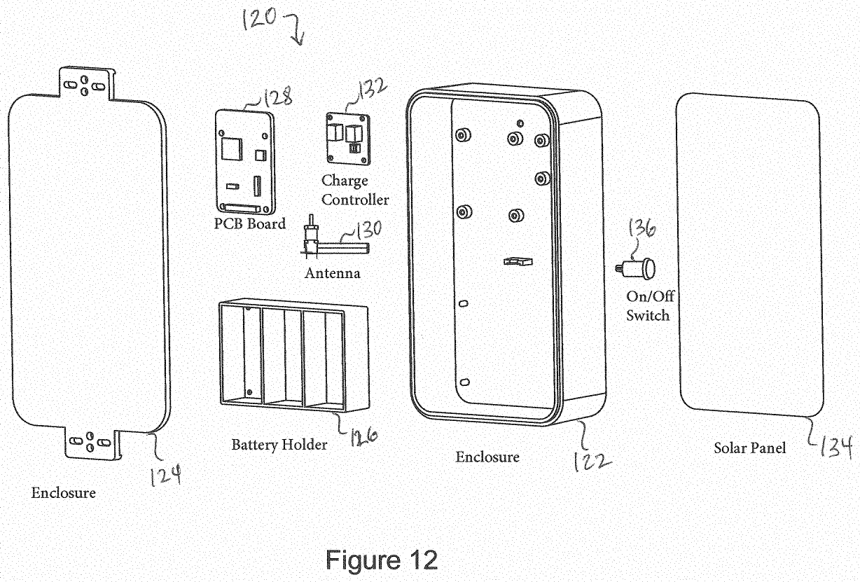

FIG. 12 illustrates an exploded view of an embodiment of a communications gateway 120 constructed in accordance with the present disclosure. The communications gateway 120 includes an enclosure 122 and an enclosure cover 124. Disposed within the enclosure 122 is a battery holder 126 that, in operation, includes one or more batteries that are usable to power a printed circuit board (PCB) 128. The PCB 128 includes a processor, transmitter, and associated circuitry thereon, coupled to an antenna 130 capable of receiving measurement data from one or more gas analyzers described above, and possibly sending control signals to the one or more gas analyzers (e.g., to trigger measurement and transmission of measurement data). The transmitter and antenna 130 are also capable of transmitting measurement data from the communications gateway 122 to another device, such as another communications gateway or to remote monitoring equipment as described earlier herein. In the illustrated embodiment, the antenna 130 is arranged internal to the gateway enclosure 122 (similar to the communications gateway 18 illustrated in FIG. 8).

A charge controller 132 is electrically coupled to the one or more batteries in the battery holder 126 so as to manage recharging of the batteries. In the illustrated embodiment, the charge controller 132 is electrically coupled to a solar panel 134 disposed on an outside surface of the enclosure 122 (similar to the communications gateway 15 shown in FIG. 6). The solar panel 134 contains photovoltaic cells that generate electrical power from sunlight, and feed the electrical power to the one or more batteries inside the gateway enclosure 122 via the charge controller 132.

An on-off switch 136 is further electrically coupled to the PCB 128 to allow manual activation and deactivation of the communications gateway 120. The on-off switch 136 may be disposed in an outer wall of the gateway enclosure 122 so as to provide external access to the switching functionality of the switch 136.

In view of the above description, various non-limiting examples of a gas analyzer 1 and system 20 that may be developed and deployed for use in condition-based monitoring may include:

1) A gas analyzer comprising a chemochromic sensor assembly with a first end adapted for insertion into electrical equipment having a dielectric insulating oil such as a transformer and a second end exposed externally of the transformer, the housing assembly having a body with an open interior; a chemochromic sensor assembly in the open interior of the body; a temperature and moisture sensor in the open interior of the body, and a color sensor, microprocessor, RF shield/transceiver and/or embedded cellular modem and lens on the second end of the module, for communication with remote monitoring equipment directly or through an external communications gateway to transmit data from the color sensor and the temperature and moisture sensor to the remote monitoring equipment.

2) The gas analyzer of example 1 wherein the temperature and moisture sensor in the open interior of the body is configured to measure the moisture and temperature of the dielectric insulating oil.

3) The gas analyzer of example 1 wherein the chemochromic sensor in the open interior of the body is sensitive to hydrogen gas and changes color when exposed to hydrogen gas.

4) The gas analyzer of example 3 wherein the chemochromic sensor reversibly changes color upon exposure to hydrogen gas.

5) The gas analyzer of example 4 wherein the chemochromic sensor contains a polyethylene terephthalate (PET) base sheet with a metal oxide film.

6) The gas analyzer of example 4 wherein the chemochromic sensor contains a fiberglass base sheet with a metal oxide film.

7) The gas analyzer of example 3, further comprising a frit adjacent chemochromic film of the chemochromic sensor, wherein the frit comprises a material that is porous to oil and hydrogen gas and the frit supports the chemochromic film.

8) The gas analyzer of example 7 wherein the frit is a sintered bronze material.

9) The gas analyzer of example 7 wherein the frit is a silica material.

10) The gas analyzer of example 7, further comprising a gas permeable membrane disposed between the frit and the chemochromic film.

11) The gas analyzer of example 10 wherein the gas permeable membrane is comprised of a fluoroelastomer material.

12) The gas analyzer of example 10 further comprising an O-ring adjacent to the gas permeable membrane that prevents the dielectric insulating oil from leaking around the gas permeable membrane.

13) The gas analyzer of example 12 wherein the O-ring is comprised of a fluoroelastomer material.

14) The gas analyzer of example 1 wherein the lens is a translucent lens arranged in a field of view of the color sensor to permit color measurement of the chemochromic sensor by the color sensor.

15) The gas analyzer of example 1 wherein the color sensor is configured to detect and measure the color of the chemochromic sensor.

16) The gas analyzer of example 1 wherein the microprocessor is configured to control data acquisition by the color sensor and/or the temperature and moisture sensor, and transmit acquired data to remote monitoring equipment either directly or through the external medications gateway.

17) The gas analyzer of example 1 wherein the RF transceiver is configured to transmit and receive radio transmissions.

18) The gas analyzer of example 1 wherein the embedded cellular modem is configured to transmit and receive transmissions.

19) The gas analyzer of example 1 wherein the remote monitoring equipment includes a web application that displays an interactive application to set alarm thresholds, set transformer nametag information, configure asset databases, review dashboards of data, review trend graphs, receive notifications, extract data and reset alarms.

20) The gas analyzer of example 1, further comprising one or more batteries to power the analyzer.

21) The gas analyzer of example 1, further comprising a bleed valve on the chemochromic sensor assembly.

22) The gas analyzer of example 1 further comprising a global positioning system (GPS) configured to provide location data of the transformer in which the analyzer is inserted.

23) A system including the gas analyzer of example 1 wherein the communications gateway includes a rechargeable battery system.

24) The system of example 23, further comprising a battery charging controller with one or more electrical inputs configured to accept power input from one or more power sources including photovoltaic cells, current transformers, piezoelectric power harvesters, and power cables.

25) The system of example 24, including a photovoltaic panel disposed on or integrated into the communications gateway.

26) The system of example 24, including an input connection for a current transformer or power supply.

27) The system of example 24, including a microprocessor in the communications gateway to control data flow through the communications gateway.

28) The system of example 24, including a radio frequency transceiver in the communications gateway to send and receive data.

29) The system of example 24, including an embedded cellular modem to send and receive data.

30) The system of example 24, including one or more magnetic mounting pads for affixing the communications gateway to a metal surface.

Accordingly, embodiments of the above examples may include a wireless sensor that measures, for example, hydrogen gas levels, temperature, and moisture in transformers and insulating oil of other electrical assets. The sensor threads into either the headspace or into the oil-filled body of the transformer or other electrical asset. A hydrogen-sensitive chemochromic assembly in an open body of the sensor is exposed to the headspace or insulating oil. The color of the chemochromic assembly changes when exposed to hydrogen. A colour sensor measures the color change of the chemochromic assembly and either displays the hydrogen concentration, temperature, and moisture on a local electronic display or transmits the measurement through a communications network to a database. The wireless network communications may use radio frequency and/or cellular communication to transmit data. Data is stored in a database and analyzed for gas detection, and displayed using, e.g., a web application to provide needed information to support operations plans and condition-based maintenance programs.

Aspects of the various embodiments described herein can be combined to provide further embodiments. All of the U.S. patents referred to in this specification are incorporated herein by reference, in their entirety. Aspects of the embodiments can be modified, if necessary, to employ concepts of the various patents to provide yet further embodiments. These and other changes can be made to the embodiments in light of the above-detailed description.

In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A gas analyzer comprising:
a housing adapted for insertion into a chamber, wherein the housing has an open interior; and
a chemochromic sensor assembly arranged in the open interior of the housing, wherein the chemochromic sensor assembly includes:
a chemochromic media,
an electronic color sensor configured and arranged with respect to the chemochromic media to sense a color of the chemochromic media, and
a processor in communication with the electronic color sensor;
wherein, in operation, the housing is inserted into a chamber, the chemochromic media is exposed to a gas within the chamber, the chemochromic media changes color depending on the gas within the chamber, and the electronic color sensor detects the color of the chemochromic media and communicates a signal to the processor based on the detected color.

2. The gas analyzer according to claim 1, wherein the processor is configured to generate gas detection information regarding the gas within the chamber based on the signal received from the electronic color sensor.

3. The gas analyzer according to claim 2, further comprising a transmitter in communication with the processor, wherein the transmitter is configured to communicate at least a portion of the gas detection information from the chemochromic sensor assembly to remote monitoring equipment.

4. The gas analyzer according to claim 3, wherein the transmitter is configured to communicate the gas detection information to a communications gateway that is separate from the gas analyzer, and the communications gateway is configured to communicate the gas detection information to the remote monitoring equipment.

5. The gas analyzer according to claim 4, further comprising a temperature and moisture sensor in the open interior of the housing, wherein:
the temperature and moisture sensor is configured to detect temperature and moisture within the chamber and communicate a signal to the processor based on the detected temperature and moisture,
the processor is configured to generate temperature and moisture information based on the signal received from the temperature and moisture sensor, and
the transmitter is configured to communicate at least a portion of the generated temperature and moisture information to the communications gateway, and the communications gateway is configured to communicate the temperature and moisture information to the remote monitoring equipment.

6. The gas analyzer according to claim 1, wherein the chamber is in an electrical transformer that contains a dielectric insulating fluid and the gas within the chamber is in the dielectric insulating fluid, and
wherein the chemochromic media is exposed to the dielectric insulating fluid and changes color depending on the gas that is in the dielectric insulating fluid.

7. The gas analyzer according to claim 6, wherein the chemochromic media is sensitive to hydrogen gas and changes color when exposed to hydrogen gas in the dielectric insulating fluid.

8. The gas analyzer according to claim 7, wherein the chemochromic media reversibly changes color upon exposure to hydrogen gas.

9. The gas analyzer according to claim 7, wherein the chemochromic media irreversibly changes color upon exposure to hydrogen gas.

10. The gas analyzer according to claim 1, further comprising a lens positioned between the chemochromic media and the electronic color sensor.

11. The gas analyzer according to claim 1, wherein the chemochromic media is a polyethylene terephthalate (PET) base sheet with a chemochromic material deposited thereon as a metal oxide film.

12. The gas analyzer according to claim 1, wherein the chemochromic media is a fiberglass base sheet with a chemochromic material deposited thereon as a metal oxide film.

13. The gas analyzer according to claim 1, wherein the chemochromic media is a glass or rigid acetyl-polymer base with a chemochromic material deposited thereon as a metal oxide film.

14. The gas analyzer according to claim 13, wherein the glass or rigid acetyl-polymer base is a lens having the chemochromic material deposited thereon.

15. The gas analyzer according to claim 14, wherein the lens is a translucent or transparent lens arranged in a field of view of the electronic color sensor to permit detection of the color of the chemochromic media by the electronic color sensor.

16. The gas analyzer according to claim 1, wherein the chemochromic sensor assembly further includes a gas permeable membrane disposed between the chemochromic media and the chamber.

17. The gas analyzer according to claim 1, wherein the gas within the chamber to which the chemochromic media is exposed is in a gas phase.

18. The gas analyzer according to claim 1, wherein the processor is further configured to control an operation of the electronic color sensor.

19. The gas analyzer according to claim 3, wherein the transmitter is an RF transmitter configured to wirelessly communicate the gas detection information via radio signal transmission.

20. The gas analyzer according to claim 3, wherein the transmitter is a cellular modem configured to wirelessly communicate the gas detection information via cellular signal transmission.

21. The gas analyzer according to claim 3, wherein the transmitter is a communication circuit configured to communicate the gas detection information via wired electrical and/or optical signal transmission.

22. The gas analyzer according to claim 1, further comprising a positioning system configured to detect a location of the chamber in which the gas analyzer housing is inserted, wherein the positioning system is configured to communicate a signal based on the detected location of the chamber.

23. A system comprising:
a plurality of gas analyzers according to claim 1 coupleable to a plurality of chambers; and
a communications gateway that is separate from the plurality of gas analyzers,
wherein:
each gas analyzer of the plurality of gas analyzers is respectively inserted into a corresponding chamber of the plurality of chambers,
each gas analyzer further comprises a transmitter in communication with the processor of the respective gas analyzer;
the transmitter in each gas analyzer is configured to communicate at least a portion of the gas detection information from the chemochromic sensor assembly of the respective gas analyzer to the communications gateway, and
the communications gateway is configured to receive the gas detection information from the plurality of gas analyzers and further communicate the gas detection information to remote monitoring equipment.

24. The system according to claim 23, wherein the communications gateway includes a rechargeable battery coupled to a battery charging controller, and wherein the battery charging controller has one or more electrical inputs configured to receive power from a power source that includes at least one of a photovoltaic cell, a current transformer, a piezoelectric power harvester, or a power cable.

25. The system according to claim 24, wherein the photovoltaic cell is disposed on or integrated into the communications gateway to supply power to the battery charging controller.

26. The system according to claim 25, wherein the communications gateway further includes:
a processor configured to control the communication of information through the communications gateway; and
a transceiver configured to receive communications from the plurality of gas analyzers and transmit information to the remote monitoring equipment,
wherein the transceiver is at least one of an RF transceiver, a cellular modem, or a wired communications circuit configured to communicate information to the remote monitoring equipment via radio signal transmission, cellular signal transmission, or wired signal transmission, respectively.
